(19) United States
(12) Patent Application Publication
(10) Pub. No.: US 2026/0009641 A1
(43) Pub. Date: Jan. 8, 2026

(54) SYSTEM FOR AUTOMATED MEASUREMENT OF LEVELNESS OF END SURFACE OF TUNNEL RING

(71) Applicant: CCCC NATIONAL ENGINEERING RESEARCH CENTER OF DREDGING TECHNOLOGY AND EQUIPMENT CO., LTD., Shanghai (CN)

(72) Inventors: Hongsheng ZHANG, Shanghai (CN); Qing XU, Shanghai (CN); Weihao SONG, Shanghai (CN); Jingdun PANG, Shanghai (CN); Daijia QU, Shanghai (CN); Yanxing HE, Shanghai (CN); Fan YI, Shanghai (CN); Zhaoxu ZHOU, Shanghai (CN)

(73) Assignee: CCCC NATIONAL ENGINEERING RESEARCH CENTER OF DREDGING TECHNOLOGY AND EQUIPMENT CO., LTD., Shanghai (CN)

(21) Appl. No.: 18/992,028

(22) PCT Filed: May 31, 2022
(86) PCT No.: PCT/CN2022/096178

§ 371 Date: Jan. 7, 2025

(30) Foreign Application Priority Data
Jun. 17, 2021 (CN) 202110670530.7

(51) Int. Cl. G01C 9/06; E21F 17/18

(52) U.S. Cl. CPC G01C 9/06; E21F 17/18; G01C 2009/066

(57) ABSTRACT

A system for the measurement of the levelness of a tunnel ring of a boring machine, which comprises laser displacement sensors, a PLC, an automated guidance system, an industrial computer, and a display; wherein the laser displacement sensors measure in real time the distance from base points to measurement points of a tunnel ring end surface when in an excavation state; the PLC obtains the distances measured by the laser displacement sensors and performs correction; the industrial computer comprises a system configuration module, a data communication module, a levelness calculation module, a data storage module, and a data visualization module; the levelness calculation module calculates spatial coordinates of each measurement point according to the distance between the base points and the measurement points, a spatial vector of an axis of a rear shield body, and base point coordinates, subsequently obtains a calibrated plane equation by means of fitting and correction, and then further calculates distance deviations between each measurement point and the calibrated plane, and provides deviation data to the data storage module and the data visualization module; and a compensatory operation is performed according to the deviation data.

### TECHNICAL FIELD

The present invention relates to the technical field of tunnel construction, specifically to a system for automated measurement of levelness of end surface of tunnel ring.

### BACKGROUND TECHNOLOGY

The general tunnel rings for supporting tunnels are wedge-shaped, one tunnel ring is spliced by a plurality of prefabricated tunnel segments, and cornering or direct movement of the tunnels is realized by selecting the splicing positions. During tunnel ring splicing, due to the influence of selection of the splicing positions and gestures of the tunneling shield, end surfaces of the tunnel ring may not be flat, subsequently, during excavation, pressure in contact surfaces between two neighboring tunnel rings where levelness is poor is too high, the concrete tunnel segments may be fractured, which may affect the engineering quality and construction safety.

To avoid the adverse influences due to the poor levelness of the tunnel rings to be spliced, levelness measurement and compensation shall be done as per the process of “end of excavation-levelness measurement-levelness compensation-tunnel ring splicing-excavation of the next ring” in order to promise smooth excavation. The interval between each of the measuring points and the calibration plane measured systematically accounts for the tunnel ring levelness, in subsequent processes, levelness compensation by sticking transmission washers of corresponding thickness on each of the measuring points shall be done in order to promise that the end surfaces of the compensated tunnel ring are as level as possible.

The manual measurement method as set forth in the foregoing paragraphs has some defects: 1. the arbitrariness of the three points is high, making it difficult to promise that the target plant calculated based on the three points is the optimum target plane without scientific and reasonable theoretical supports. 2. With this method, the coordinates of the points are to be measured with a total station, in view of spatial limitations of tunneling construction, it is difficult to measure manually, the operation is not convenient and measuring efficiency and timeliness is poor, which goes against the timeliness requirements of tunneling construction.

### SUMMARY OF INVENTION

In view of the foregoing problems, first of all, an accurate and automatic measurement algorithm for levelness of tunnel rings is proposed;
Further, the present invention designed and proposed a system for automated measurement of levelness of end surface of tunnel ring.

The technical solution to be claimed: a system for automated measurement of levelness of end surface of tunnel ring, wherein the system is integrated with a levelness measurement function for end surfaces of tunnel segments of a tunneling shield; the levelness measurement system for the tunnel segments of the tunneling shield comprises at least one laser sensor, at least one programmable logic controller (PLC), at least one automatic guiding system, at least one industrial computer, and at least one display, wherein
At least one laser displacement sensor is installed on an assembly plane of thrust cylinders of the tunneling shield, each of the at least one laser displacement sensor is installed in a gap between the neighboring thrust cylinders, emitting laser light parallel to an axial line of the thrust cylinders, perpendicular to the assembly plane of the thrust cylinders and orienting to the end surface of the tunnel ring to be measured; intersections between a line where the laser light is and the assembly plane of the thrust cylinders are called base points Pᵢ, intersections with the end surface to be measured are called measuring points P′ᵢ, and the at least one laser displacement sensor measures in real time intervals between the base points and the measuring points P′ᵢ of the end surface of the tunnel ring during excavation;
As an embodiment, the at least one PLC can be a control system apparatus available in the tunneling shield, the at least one PLC is connected with the at least one laser displacement sensor, the at least one PLC acquires an analogue quantity corresponding to distances measured by the at least one laser displacement sensor and converts the analogue quantity to a digital quantity; and the at least one PLC is configured to calibrate the distances measured according to installation conditions of the at least one laser displacement sensor;
The at least one automatic guiding system comprises the automatic guiding system available in the tunneling shield, the at least one automatic guiding system is configured to measure spatial vectors of an axial line of a rear shield of the tunneling shield, conduce installation positions of the at least one laser displacement sensor (coordinates of the base points Pᵢ) and transmit to the at least one PLC;
The automatic guiding system comprises a gesture measuring system inherent in the tunneling shield, in the system, spatial coordinates for a shield head, a hinging portion and a shield tail are present, the least one laser displacement sensor is fixed at the rear shield of the tunneling shield, therefore, the base points Pᵢ corresponding to the at least one laser displacement sensor and relative spatial relationships with the hinging portion and the shield tail of the tunneling shield are fixed; as per the relative spatial relationships, the automatic guiding system can calculate the spatial coordinates Pᵢ(xᵢ, yᵢ, zᵢ) of the base points Pᵢ. Therefore, the automatic guiding system in the present invention can provide axial spatial vectors of the rear shield of the tunneling shield n_{shield}=(xₙ, yₙ, zₙ) and the installation positions of the laser displacement sensors (the coordinates of the base points Pᵢ(xᵢ, yᵢ, zᵢ)).

As an embodiment, the at least one industrial computer comprises an industrial computer existing in the tunneling shield, the at least one industrial computer comprises an upper computer, comprising a system configuration module, a data communication module, a flatness calculation module, a data storage module and a data visualization module;
Wherein the system configuration module is configured to set software parameters, c comprising measuring cycles and device IPs; a working staff can input via a human-computer interface into the at least one PLC corresponding parameters including alignment parameters of sensors;
The data communication module is configured to communicate in between the at least one industrial computer and the at least one PLC so to acquire data including distances lᵢ from the base points Pᵢ to the measuring points Pᵢ′ of the at least one laser displacement sensor, the axial spatial vectors of the rear shield of the tunneling shield n_{shield} and the coordinates of the base point Pᵢ(xᵢ, yᵢ, zᵢ);
The levelness calculation module is a core of the application software of the present system, employed to calculate the spatial coordinates of each of the measuring points based on the distances between the base points to the measuring points, the axial spatial vectors of the rear shield and the coordinates of the base points, obtain a calibration plane equation by fitting computation and correction, and further obtain distance deviation values between each of the measuring points and the calibration plane; provide deviation data to the data storage module and the data visualization module; conduct compensation making use of washers and foreign facilities based on the deviation data or make compensation operations by a staff with reference to visualized deviation data;
The data storage module is configured for storage and access of initial measuring values and computation results;
The data visualization module is configure to display values of each of the measuring points based on values and results calculated by the levelness calculation module in a form of graphs which facilitates appreciation and observation of the staff;
After levelness compensation and tunnel ring splicing, the tunneling shield will excavate, and the present measurement system will start automatically and start levelness measurement.

Further, the levelness calculation module: the calculation method of the levelness calculation module is explained using an example of calculating the distance deviation values corresponding to the measuring points of the tunnel ring. The intersections between a line where the laser light is and the assembly plane of the thrust cylinders are called the base points Pᵢ, the intersections with the end surfaces to be measured are called the measuring points P′ᵢ, spatial coordinates corresponding to each of the base points are shown as Pᵢ(xᵢ, yᵢ, zᵢ); spatial coordinates of each of the measuring points are shown as Pᵢ′(xᵢ′, yᵢ′, zᵢ′); a plane obtained by a first fitting is called a reference plane, shown as α₀; a plane obtained by translating the reference plane α₀ to a plane of a calibration position is called a calibration plane, shown as α₁; distances from the base points to the reference plane α₀ are shown as Δdᵢ and distances from the base points and the calibration plane α₁ are shown as dᵢ.
(1) Obtaining an axial vector n_{rear shield}=(xₙ, yₙ, zₙ) from a programmable logic controller (PLC), coordinates Pᵢ(xᵢ, yᵢ, zᵢ) of root portions of the thrust cylinders and distances lᵢ from the base points to the measuring points of the laser displacement sensor.
(2) n_{rear shield} is a normal vector of a circular plane that the base points corresponding to the laser displacement sensors are located in, as vectors formed by lasers emitted by the laser displacement sensor are parallel to the normal vector n_{rear shield} and the distances from the base points to the measuring points are lᵢ, on this basis, an equation is obtained and coordinates of the measuring points Pᵢ′(xᵢ′, yᵢ′, zᵢ′) are solved:

$$\{ \begin{matrix}{x}_{i}^{′} = \frac{{l}_{i} \cdot {x}_{n}}{\sqrt{{x}_{n}^{2} + {y}_{n}^{2} + {z}_{n}^{2}}} + {x}_{i} \\ {y}_{i}^{′} = \frac{{l}_{i} \cdot {y}_{n}}{\sqrt{{x}_{n}^{2} + {y}_{n}^{2} + {z}_{n}^{2}}} + {y}_{i} \\ {z}_{i}^{′} = \frac{{l}_{i} \cdot {z}_{n}}{\sqrt{{x}_{n}^{2} + {y}_{n}^{2} + {z}_{n}^{2}}} + {z}_{i}\end{matrix}$$

(3) In an ideal case, the coordinates of the measuring points are located in the same plane, and a mathematical model showing distribution of the measuring points can be shown as a planar equation.
   In a three-dimensional space, by fitting and calculating parameters of the reference planar equation by linear regression or SVD decomposition methods based on coordinates of the measuring points, an equation of the reference plane α₀ can be obtained, taking as an example the least square, the planar equation can be shown as

$$\{ \begin{matrix}Ax + By + Cz + 1 = 0 \\ [ \begin{matrix}\begin{matrix}A \\ B\end{matrix} \\ C\end{matrix} ] = {{( {[ \begin{matrix}{x}_{1}^{′} & {y}_{1}^{′} & {z}_{1}^{′} \\ ⋮ & ⋮ & ⋮ \\ {x}_{n}^{′} & {y}_{n}^{′} & {z}_{n}^{′}\end{matrix} ]}^{T} [ \begin{matrix}{x}_{1}^{′} & {y}_{1}^{′} & {z}_{1}^{′} \\ ⋮ & ⋮ & ⋮ \\ {x}_{n}^{′} & {y}_{n}^{′} & {z}_{n}^{′}\end{matrix} ] )}^{- 1} [ \begin{matrix}{x}_{1}^{′} & {y}_{1}^{′} & {z}_{1}^{′} \\ ⋮ & ⋮ & ⋮ \\ {x}_{n}^{′} & {y}_{n}^{′} & {z}_{n}^{′}\end{matrix} ]}^{T} [ \begin{matrix}\begin{matrix}- 1 \\ ⋮\end{matrix} \\ - 1\end{matrix} ]\end{matrix}$$

(4) The normal vectors of the reference plane α₀ are n_{reference plane}=(A, B, C) and a dot product of the normal vector n_{rear shield} of the cross section at the tail end portion of the shield is dot₀=n_{reference plane}·n_{rear shield}. Selecting arbitrarily a point P′(x₀′, y₀′, z₀′) in a plane, obtaining vectors of the point orienting to the measuring points \vec{P′Pᵢ′}=(xᵢ′−x₀′, yᵢ′−y₀′, zᵢ′−z₀′) calculating the dot product dotᵢ=n_{reference plane}−\vec{P′Pᵢ′}, where dot₀·dot₁>0, the measuring points Pᵢ(xᵢ, yᵢ, zᵢ) are located at a side along the excavation direction. And with this method, all the measuring points at the side along the excavation direction of the reference plane α₀ can be found.
(5) Calculating distances

$$Δ {d}_{k} = \frac{\vert {Ax}_{k} + B {y}_{k} + C {z}_{k} + 1 \vert}{\sqrt{{A}^{2} + {B}^{2} + {C}^{2}}}$$

from the measuring points at a side along the excavation direction and the reference plane, and selecting coordinates of the measuring point corresponding to the maximum distance Pₘₐₓ(xₘₐₓ, yₘₐₓ, zₘₐₓ).
(6) Translating the reference plane along the excavation direction of the tunneling shield until passing the point Pₘₐₓ(xₘₐₓ, yₘₐₓ, zₘₐₓ), the plane obtained is the calibration plane α₁ and the equation is:

$$Ax + By + Cz - ( {Ax}_{max} + {By}_{max} + {Cz}_{max} ) = 0$$

(7) Calculating the distances from the measuring points to the calibration plane with the following equation, and obtaining distance deviations from the measuring points along the cross section at the front portion of the tunnel ring to the calibration plane α₁:

$${d}_{i} = \frac{\vert {Ax}_{i} + B {y}_{i} + C {z}_{i} − ( A {x}_{max} + B {y}_{max} + C {z}_{max} ) \vert}{\sqrt{{A}^{2} + {B}^{2} + {C}^{2}}}$$

A, B and C in the foregoing equations stand for three coefficients of an equation of a plane.

Compared with manual measurement methods, the beneficial effects of the method proposed in the present invention are:

In the present invention, the total station in the automatic guiding system of the tunneling shield is used to obtain corresponding spatial position data, in conjunction with the distances between the base points and the measuring points measured by the at least one laser displacement sensor, deviation distances of the measuring points can be automatically calculated in real time, time-consuming labors associated with installing the total station manually to measure the spatial coordinates of the measuring points in the cross sections are avoided. Compared with calculating the calibration plane by selecting arbitrarily three points after obtaining the measurement data, with the method proposed in the present invention the levelness measurement results of the tunnel segments have high precision by obtaining the calibration plane by data fitting so that the calibration plane is closer to the positions of the measuring points.

### BRIEF DESCRIPTION OF DRAWINGS

FIG. 1 is a system hardware configuration diagram showing a system for automated measurement of levelness of end surface of tunnel ring according to an embodiment.

FIG. 2 is a software configuration diagram for the system according to an embodiment.

FIG. 3 is a running process diagram of the system according to an embodiment.

FIG. 4 shows application conditions and distances between base points and measuring points.

FIG. 5 shows the measuring points obtained using axial vectors of the rear shield.

FIG. 6 shows solving the calibration plane and levelness calculation.

### EMBODIMENTS

Hereinafter a brief description will be given to the present invention in conjunction with the drawings.

Embodiment 1 discloses an accurate and automatic measurement algorithm for levelness of tunnel rings.

The intersections between a line where the laser light is and the assembly plane of the thrust cylinders are called base points Pᵢ, intersections between the end surface to be measure are called measuring points P′₁; spatial coordinates corresponding to each of the base points are shown as Pᵢ(xᵢ, yᵢ, zᵢ); spatial coordinates of each of the measuring points are shown as Pᵢ′(xᵢ′, yᵢ′, zᵢ′); a plane obtained by a first fitting is called a reference plane, shown as α₀; a plane obtained by translating the reference plane α₀ to a plane of a calibration position is called a calibration plane, shown as α₁; distances from the base points to the reference plane α₀ are shown as Δdᵢ and distances from the base points and the calibration plane α₁ are shown as dᵢ.
(1) Obtaining an axial vector n_{rear shield}=(xₙ, yₙ, zₙ) from a programmable logic controller (PLC), coordinates Pᵢ(xᵢ, yᵢ, zᵢ) of root portions of the thrust cylinders and distances lᵢ from the base points to the measuring points of the laser displacement sensor.
(2) n_{rear shield} is a normal vector of a circular plane that the base points corresponding to the laser displacement sensor are located in, as vectors formed by lasers emitted by the laser displacement sensor are parallel to the normal vector n_{rear shield} and the distances from the base points to the measuring points are lᵢ, on this basis, an equation is obtained and coordinates of the measuring points Pᵢ′(xᵢ′, yᵢ′, zᵢ′) are solved:

$$\{ \begin{matrix}{x}_{i}^{′} = \frac{{l}_{i} \cdot {x}_{n}}{\sqrt{{x}_{n}^{2} + {y}_{n}^{2} + {z}_{n}^{2}}} + {x}_{i} \\ {y}_{i}^{′} = \frac{{l}_{i} \cdot {y}_{n}}{\sqrt{{x}_{n}^{2} + {y}_{n}^{2} + {z}_{n}^{2}}} + {y}_{i} \\ {z}_{i}^{′} = \frac{{l}_{i} \cdot {z}_{n}}{\sqrt{{x}_{n}^{2} + {y}_{n}^{2} + {z}_{n}^{2}}} + {z}_{i}\end{matrix}$$

(3) In an ideal case, the coordinates of the measuring points are located in the same plane, and a mathematical model showing distribution of the measuring points can be shown as a planar equation.
   In a three-dimensional space, by fitting and calculating parameters of the reference planar equation by linear regression or SVD decomposition methods based on coordinates of the measuring points, an equation of the reference plane α₀ can be obtained, taking as an example the least square, the planar equation can be shown as

$$\{ \begin{matrix}Ax + By + Cz + 1 = 0 \\ [ \begin{matrix}\begin{matrix}A \\ B\end{matrix} \\ C\end{matrix} ] = {{( {[ \begin{matrix}{x}_{1}^{′} & {y}_{1}^{′} & {z}_{1}^{′} \\ ⋮ & ⋮ & ⋮ \\ {x}_{n}^{′} & {y}_{n}^{′} & {z}_{n}^{′}\end{matrix} ]}^{T} [ \begin{matrix}{x}_{1}^{′} & {y}_{1}^{′} & {z}_{1}^{′} \\ ⋮ & ⋮ & ⋮ \\ {x}_{n}^{′} & {y}_{n}^{′} & {z}_{n}^{′}\end{matrix} ] )}^{- 1} [ \begin{matrix}{x}_{1}^{′} & {y}_{1}^{′} & {z}_{1}^{′} \\ ⋮ & ⋮ & ⋮ \\ {x}_{n}^{′} & {y}_{n}^{′} & {z}_{n}^{′}\end{matrix} ]}^{T} [ \begin{matrix}\begin{matrix}- 1 \\ ⋮\end{matrix} \\ - 1\end{matrix} ]\end{matrix}$$

(4) The normal vectors of the reference plane α₀ are n_{reference plane}=(A, B, C) and a dot product of the normal vector n_{rear shield} of the cross section at the tail end portion of the shield is dot₀=n_{reference plane}·n_{rear shield}. Selecting arbitrarily a point P′(x₀′, y₀′, z₀′) in a plane, obtaining vectors of the point orienting to the measuring points \vec{P′Pᵢ′}=(xᵢ′−x₀′, yᵢ′−y₀′, zᵢ′−z₀′) calculating the dot product dot₁=n_{reference plane}·\vec{P′Pᵢ′}, where dot₀·dot₁>0, the measuring points Pᵢ(xᵢ, yᵢ, zᵢ) are located at a side along the excavation direction. And with this method, all the measuring points at the side along the excavation direction of the reference plane α₀ can be found.
(5) Calculating distances

$$Δ {d}_{k} = \frac{\vert {Ax}_{k} + B {y}_{k} + C {z}_{k} + 1 \vert}{\sqrt{{A}^{2} + {B}^{2} + {C}^{2}}}$$

from the measuring points at a side along the excavation direction and the reference plane, and selecting coordinates of the measuring point corresponding to the maximum distance Pₘₐₓ(xₘₐₓ, yₘₐₓ, zₘₐₓ).
(6) Translating the reference plane along the excavation direction of the tunneling shield until passing the point Pₘₐₓ(xₘₐₓ, yₘₐₓ, zₘₐₓ), the plane obtained is the calibration plane α₁ and the equation is:

$$Ax + By + Cz - ( {Ax}_{max} + {By}_{max} + {Cz}_{max} ) = 0$$

(7) Calculating the distances from the measuring points to the calibration plane with the following equation, and obtaining distance deviations from the measuring points along the cross section at the front portion of the tunnel ring to the calibration plane α₁:

$${d}_{i} = \frac{\vert {Ax}_{i} + B {y}_{i} + C {z}_{i} − ( A {x}_{max} + B {y}_{max} + C {z}_{max} ) \vert}{\sqrt{{A}^{2} + {B}^{2} + {C}^{2}}} .$$

### Embodiment 2

Based on the technical solution of the algorithm as provided in embodiment 1, an embodiment and technical principle of the automatic levelness measurement system of end surface of tunnel ring is further provided in the present embodiment of the present invention.

The system for automated measurement of levelness of end surface of tunnel ring writes in C#/C++/Python languages, is run in an industrial computer inherent in the tunneling shield, the AD conversion and data communication of the slave computer is realized by the PLC inherent in the tunneling shield and the measurement calculation function of the axial vector of the rear shield of the tunneling shield and the coordinates of the base points is done by the automatic guiding system inherent in the tunneling shield.

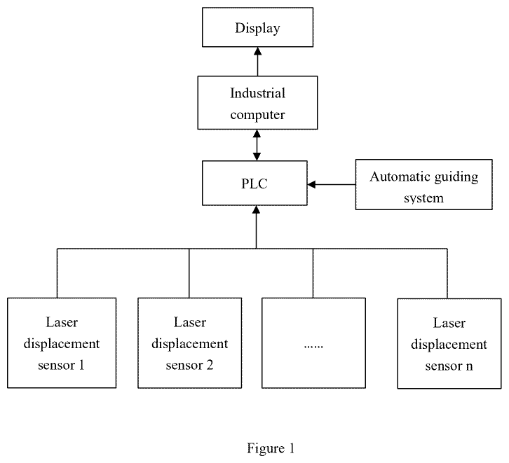

As shown in FIG. 1, the system hardware comprises laser displacement sensors, an automatic guiding system, a PLC, an industrial computer and a display. Wherein the laser displacement sensors are configured to obtain distances between the base points and the measuring points; the automatic guiding system is configured to measure and calculate axial vectors of the rear shield of the tunneling shield, coordinates of the base points and transmit to the PLC; the PLC is configured to obtain signals of the sensors and complete AD conversion and data alignment, obtain coordinate data of corresponding positions from the guiding system and store the corresponding address; the industrial computer is configured to run the system software, read corresponding data from the PLC and calculate the distance deviations corresponding to the measuring points and the display is configured to display the corresponding deviation values of the measuring points in a visualized form.

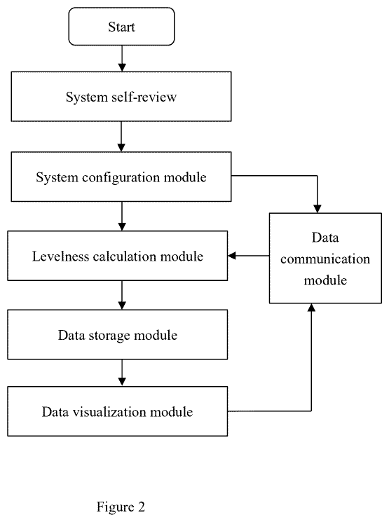

As per FIG. 2, the system software architecture diagram, the system software comprises a system configuration module, a data communication module, a levelness calculation module, a data storage module and a data visualization module. Wherein the system configuration module is configured to set software parameters such as measurement cycles, device IPs, and quantities of the devices; the data communication module is configured to communicate with the industrial computer and the PLC for obtaining the distances between the base points and the measuring points, the axial vectors of the rear shield, and spatial coordinates of the base points; the levelness calculation module is a core of the present system, configured primarily to obtain the distance deviations between the measuring points and the calibration plane; the data storage module is configured for storage and access of initial measurement values and the calculation results; and the data visualization module is configured to display values of the measuring points in a visualized form that is easy for operators to understand and observe and provide reference data for an external system or person to select the washers.

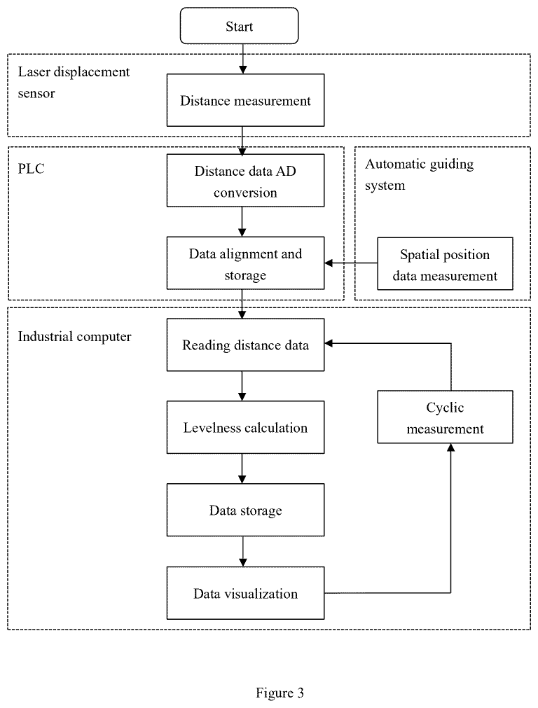

As shown in FIG. 3, the system running process diagram, first of all, the laser displacement sensors measure the distances between the base points and the measuring points; the analogue signals corresponding to the distances there between are converted to be corresponding digital quantities by the PLC, and stored in a corresponding address after further data alignment; the automatic guiding system measures and calculates the axial vectors of the rear shield of the tunneling shield and the spatial coordinates of the base points and transmits to the PLC; the industrial computer reads the distances between the base points and the measuring points, axial vectors of the rear shield and the spatial coordinates of the base points from the PLC, thereby calculates a reference plane by fitting, obtains the calibration plane after treatment according to the alignment rules, and calculates the deviation distances between the measuring points and the calibration plane; exhibits the deviation distances on the display to make it convenient for operators to use and compensate; repeating the measuring processes and exhibiting the measurement result periodically; on the basis of obtaining the distance deviations of the measuring points, deciding specifications and quantities of washers for compensation in the measuring points according to the thickness specifications of the existing washers manually.

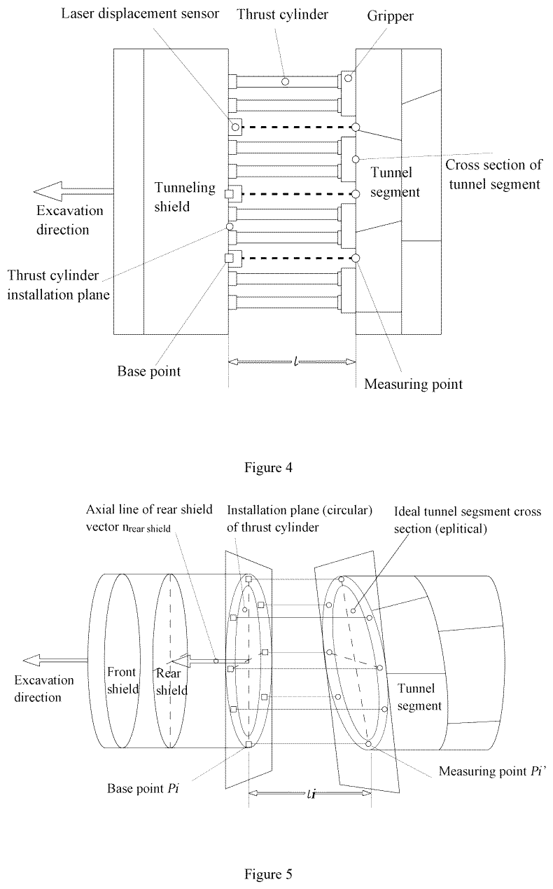

FIGS. 4-6 are employed to illustrate the principles and core algorithms of calculating the levelness of the end surface of the tunnel ring by the levelness calculation module in the system (which is disclosed in embodiment 1).

As shown in FIG. 4, the laser displacement sensor is installed on an oil cylinder installation plane, in a gap between neighboring thrust cylinders, emitting laser light perpendicular to the installation plane, the intersections between the lines where the laser displacement sensors and the assembly plane of the thrust cylinder intersect are called the base points Pᵢ, and the intersections with the tunnel ring end surfaces to be measured are called P′ᵢ. The distances between the base points and the measuring points are measured by the laser displacement sensors.

As shown in FIG. 5, the coordinates of the measuring points can be calculated by the coordinates of the base points, the axial vectors of the rear shield, and the distances between the base points and the measuring points. In an ideal case, the measuring points along the foremost end surface before and after tunnel segment splicing are located on the same plane; therefore, a mathematic model of a spatial plane can be employed to describe spatial distribution of the measuring points.

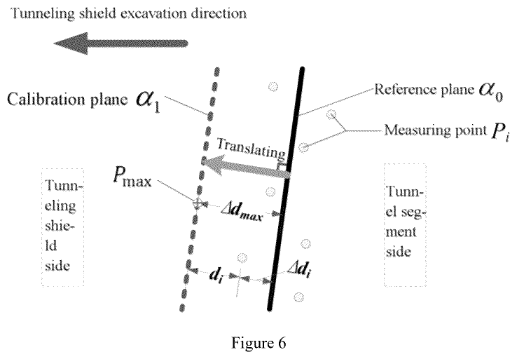

The calculation principle is as shown in FIG. 6: conducting data fitting according to the coordinates of the measuring points in the three-dimensional spatial rectangular coordinate system and obtaining the reference plane α₀ (solid lines in the figures). To promise that all the measuring points are located at a side of the tunnel ring of the calibration plane to facilitate subsequent deviation compensation, the measuring point at the side along the excavation direction of the reference plane α₀ and that is the farthest from the reference plane α₀ is selected, translating the reference plane α₀ along the excavation direction of the tunneling shield until passing the point at the farthest, and the plane obtained at this time corresponds to the calibration plane α₁ (dotted lines in the figures). Calculating the distances from the measuring points to the calibration plane α₁ and obtaining the deviations of the measuring points relative to the calibration plane α₁ in the three-dimensional space.

1. A system for automated measurement of levelness of end surface of tunnel ring, comprises at least one laser sensor, at least one programmable logic controller (PLC), at least one automatic guiding system, at least one industrial computer, and at least one display, wherein
at least one laser displacement sensor is installed on an assembly plane of thrust cylinders of the tunneling shield, each of the at least one laser displacement sensor is installed in a gap between the neighboring thrust cylinders, emitting laser light parallel to an axial line of the thrust cylinders, perpendicular to the assembly plane of the thrust cylinders and orienting to the end surface of the tunnel ring to be measured; intersections between a line where the laser light is and the assembly plane of the thrust cylinders are called base points Pᵢ, intersections with the end surface to be measured are called measuring points P′ᵢ, and the at least one laser displacement sensor measures in real time intervals between the base points and the measuring points P′ᵢ of the end surface of the tunnel ring during excavation;
the at least one PLC is connected with the at least one laser displacement sensor, the at least one PLC acquires an analogue quantity corresponding to distances measured by the at least one laser displacement sensor and converts the analogue quantity to a digital quantity; and the at least one PLC is configured to calibrate the distances measured according to installation conditions of the at least one laser displacement sensor;
the at least one automatic guiding system comprises the automatic guiding system available in the tunneling shield, the at least one automatic guiding system is configured to measure spatial vectors of an axial line of a rear shield of the tunneling shield, conduce installation positions of the at least one laser displacement sensor, coordinates of the base points Pᵢ and transmit to the at least one PLC;
the at least one automatic guiding system comprises a gesture measuring system inherent in the tunneling shield, in the system, spatial coordinates for a shield head, a hinging portion and a shield tail are present, the least one laser displacement sensor is fixed at the rear shield of the tunneling shield, therefore, the base points Pᵢ corresponding to the at least one laser displacement sensor and relative spatial relationships with the hinging portion and the shield tail of the tunneling shield are fixed; as per the relative spatial relationships, the automatic guiding system can calculate the spatial coordinates Pᵢ(xᵢ, yᵢ, zᵢ) of the base points Pᵢ and provide axial spatial vectors of the rear shield of the tunneling shield n_{shield}=(xₙ, yₙ, zₙ) and the installation positions of the at least one laser displacement sensor, the coordinates of the base points Pᵢ(xᵢ, yᵢ, zᵢ);
the at least one industrial computer comprises an industrial computer existing in the tunneling shield, the at least one industrial computer comprises an upper computer, comprising a system configuration module, a data communication module, a flatness calculation module, a data storage module and a data visualization module;
wherein the system configuration module is configured to set software parameters, c comprising measuring cycles and device IPs; a working staff can input via a human-computer interface into the at least one PLC corresponding parameters including alignment parameters of sensors;
the data communication module is configured to communicate in between the at least one industrial computer and the at least one PLC so to acquire data including distances lᵢ from the base points Pᵢ to the measuring points Pᵢ′ of the at least one laser displacement sensor, the axial spatial vectors of the rear shield of the tunneling shield n_{shield} and the coordinates of the base point Pᵢ(xᵢ, yᵢ, zᵢ);
the levelness calculation module is a core of the application software of the present system, employed to calculate the spatial coordinates of each of the measuring points based on the distances between the base points to the measuring points, the axial spatial vectors of the rear shield and the coordinates of the base points, obtain a calibration plane equation by fitting computation and correction, and further obtain distance deviation values between each of the measuring points and the calibration plane; provide deviation data to the data storage module and the data visualization module; conduct compensation making use of washers and foreign facilities based on the deviation data or make compensation operations by a staff with reference to visualized deviation data;
the data storage module is configured for storage and access of initial measuring values and computation results;
the data visualization module is configure to display values of each of the measuring points based on values and results calculated by the levelness calculation module in a form of graphs which facilitates appreciation and observation of the staff;
after levelness compensation and tunnel ring splicing, the tunneling shield will excavate, and the present measurement system will start automatically and start levelness measurement;
Further, the levelness calculation module calculates the distance deviation values corresponding to the measuring points of the tunnel ring, comprising: the intersections between a line where the laser light is and the assembly plane of the thrust cylinders are called the base points Pᵢ, the intersections with the end surfaces to be measured are called the measuring points P′ᵢ, spatial coordinates corresponding to each of the base points are shown as Pᵢ(xᵢ, yᵢ, zᵢ); spatial coordinates of each of the measuring points are shown as Pᵢ′(xᵢ′, yᵢ′, zᵢ′); a plane obtained by a first fitting is called a reference plane, shown as α₀; a plane obtained by translating the reference plane α₀ to a plane of a calibration position is called a calibration plane, shown as α₁; distances from the base points to the reference plane α₀ are shown as Δdᵢ and distances from the base points and the calibration plane α₁ are shown as dᵢ;
(1) obtaining an axial vector n_{rear shield}=(xₙ, yₙ, zₙ) from a programmable logic controller (PLC), coordinates Pᵢ(xᵢ, yᵢ, zᵢ) of root portions of the thrust cylinders and distances lᵢ from the base points to the measuring points of the laser displacement sensor;
(2) n_{rear shield} is a normal vector of a circular plane that the base points corresponding to the laser displacement sensor are located in, as vectors formed by lasers emitted by the laser displacement sensor are parallel to the normal vector n_{rear shield} and the distances from the base points to the measuring points are lᵢ, on this basis, an equation is obtained and coordinates of the measuring points Pᵢ′(xᵢ′, yᵢ′, zᵢ′) are solved:
$$\{ \begin{matrix}{x}_{i}^{′} = \frac{{l}_{i} \cdot {x}_{n}}{\sqrt{{x}_{n}^{2} + {y}_{n}^{2} + {z}_{n}^{2}}} + {x}_{i} \\ {y}_{i}^{′} = \frac{{l}_{i} \cdot {y}_{n}}{\sqrt{{x}_{n}^{2} + {y}_{n}^{2} + {z}_{n}^{2}}} + {y}_{i} \\ {z}_{i}^{′} = \frac{{l}_{i} \cdot {z}_{n}}{\sqrt{{x}_{n}^{2} + {y}_{n}^{2} + {z}_{n}^{2}}} + {z}_{i}\end{matrix}$$
(3) in a three-dimensional space, by fitting and calculating parameters of the reference planar equation by linear regression or SVD decomposition methods based on coordinates of the measuring points, an equation of the reference plane α₀ can be obtained, using the least square, the planar equation can be shown as
$$\{ \begin{matrix}Ax + By + Cz + 1 = 0 \\ [ \begin{matrix}\begin{matrix}A \\ B\end{matrix} \\ C\end{matrix} ] = {{( {[ \begin{matrix}{x}_{1}^{′} & {y}_{1}^{′} & {z}_{1}^{′} \\ ⋮ & ⋮ & ⋮ \\ {x}_{n}^{′} & {y}_{n}^{′} & {z}_{n}^{′}\end{matrix} ]}^{T} [ \begin{matrix}{x}_{1}^{′} & {y}_{1}^{′} & {z}_{1}^{′} \\ ⋮ & ⋮ & ⋮ \\ {x}_{n}^{′} & {y}_{n}^{′} & {z}_{n}^{′}\end{matrix} ] )}^{- 1} [ \begin{matrix}{x}_{1}^{′} & {y}_{1}^{′} & {z}_{1}^{′} \\ ⋮ & ⋮ & ⋮ \\ {x}_{n}^{′} & {y}_{n}^{′} & {z}_{n}^{′}\end{matrix} ]}^{T} [ \begin{matrix}\begin{matrix}- 1 \\ ⋮\end{matrix} \\ - 1\end{matrix} ]\end{matrix}$$
(4) the normal vectors of the reference plane α₀ are n_{reference plane}=(A, B, C) and a dot product of the normal vector n_{rear shield} of the cross section at the tail end portion of the shield is dot₀=n_{reference plane}·n_{rear shield}. Selecting arbitrarily a point P′(x₀′, y₀′, z₀′) in a plane, obtaining vectors of the point orienting to the measuring points \vec{P′Pᵢ′}=(xᵢ′−x₀′, yᵢ′−y₀′, zᵢ′−z₀′), calculating the dot product dot₁=n_{reference plane}·\vec{P′Pᵢ′}, where dot₀·dot₁>0, the measuring points Pᵢ(xᵢ, yᵢ, zᵢ) are located at a side along the excavation direction. And with this method, all the measuring points at the side along the excavation direction of the reference plane α₀ can be found;
(5) calculating distances
$$Δ {d}_{k} = \frac{\vert {Ax}_{k} + B {y}_{k} + C {z}_{k} + 1 \vert}{\sqrt{{A}^{2} + {B}^{2} + {C}^{2}}}$$
from the measuring points at a side along the excavation direction and the reference plane, and selecting coordinates of the measuring point corresponding to the maximum distance Pₘₐₓ(xₘₐₓ, yₘₐₓ, zₘₐₓ);
(6) translating the reference plane along the excavation direction of the tunneling shield until passing the point Pₘₐₓ(xₘₐₓ, yₘₐₓ, zₘₐₓ), the plane obtained is the calibration plane α₁ and the equation is:
$$Ax + By + Cz - ( {Ax}_{max} + {By}_{max} + {Cz}_{max} ) = 0$$
(7) calculating the distances from the measuring points to the calibration plane with the following equation, and obtaining distance deviations from the measuring points along the cross section at the front portion of the tunnel ring to the calibration plane α₁:
$${d}_{i} = \frac{\vert {Ax}_{i} + B {y}_{i} + C {z}_{i} − ( A {x}_{max} + B {y}_{max} + C {z}_{max} ) \vert}{\sqrt{{A}^{2} + {B}^{2} + {C}^{2}}}$$
A, B and C in the foregoing equations stand for three coefficients of an equation of a plane.
